(19) United States
(12) Patent Application Publication
(10) Pub. No.: US 2005/0271370 A1
(43) Pub. Date: Dec. 8, 2005

(54) Optical disc apparatus

(75) Inventor: Mitsuharu Osaki, Osaka (JP)

Correspondence Address: MORGAN LEWIS & BOCKIUS LLP, 1111 PENNSYLVANIA AVENUE NW, WASHINGTON, DC, 20004, US

(73) Assignee: FUNAI ELECTRIC CO., LTD.

(21) Appl. No.: 11/139,601

(22) Filed: May 31, 2005

(30) Foreign Application Priority Data
Jun. 2, 2004 (JP) P2004-164047

(51) Int. Cl. H04N 5/781

(52) U.S. Cl. 386/126

(57) ABSTRACT

In an optical disc apparatus, when only weekly-program setting is entered to a weekly-program setting row on a setup screen, a back end MCU performs weekly-program setting. When weekly-program setting is entered to the weekly-program setting row and single-program setting is entered to a single-program setting row, the back end MCU performs a recording operation preferentially for the single-program setting, without canceling the weekly-program setting.

### BACKGROUND OF THE INVENTION

1. Field of the Invention

The present invention relates to an optical disc apparatus including a recording controller that records a program setting information in a predetermined area of a disc-shaped recording medium, and that initiates a recording operation based on the program setting information read from the disc-shaped recording medium.

2. Description of the Related Art

Recently, optical disc apparatuses that handle disc-shaped recording media, such as DVDs, have rapidly wide spread.

This type of optical disc apparatus, as well as a conventional video cassette recorder, has a program setting function using a timer. In order to improve the usability of the program setting function, optical disc apparatuses have been proposed wherein program setting information is recorded in a predetermined area of a disc-shaped recording media, and the recording operation is initiated based on the program setting information read from the disc-shaped recording medium (see, for example, JP-A-6-20382 and JP-A-11-339376).

According to these optical disc apparatuses, when program setting information written to each optical disc differs, program setting can also be changed only by exchanging an optical disc.

### SUMMARY OF THE INVENTION

As is described above, according to the conventional optical disc apparatus, the program setting information can be recorded on the optical disc, and the program setting can be changed simply by changing the optical disc. Therefore, the usability is superior for users.

However, when desired programs to be recorded are overlapped, and when program setting information for these programs is recorded on the optical disc, an apparatus that reads this information cannot handle the information, and an erroneous operation occurs.

Furthermore, assume that weekly-program setting information, indicating recording for a specified period of time beginning at a fixed time on a fixed day every week, is recorded on a disc-shaped recording medium, and that a special full-length program is to be broadcasted at the same time slot. When the special program is to be recorded, first, the weekly-program setting must be canceled, and program setting for the special program should be performed, and after the special program has been recorded, the weekly-program setting must be performed again. Thus, in this case, the usability is not always superior for the user.

In JP-A-11-339376, an adjustment method is disclosed when the timer setting information recorded on a disc is overlapped with timer setting information registered in the apparatus. However, this method is merely for the adjustment between the timer setting information recorded on the disc and the timer setting information registered in the apparatus, and not for the adjustment of the timer setting information that is recorded and overlapped on the same disc.

While taking such a program setting situation into account, an objective of the invention is to provide an optical disc apparatus wherein, when weekly-program setting information is recorded on an optical disc, and when a different full-length program broadcasted at the same time slot is to be recorded, the different full-length program can be recorded without canceling the weekly-program setting.

To achieve this objective, an optical disc apparatus according to an aspect of the invention includes: a recording controller for recording program setting information to a predetermined area of a disc-shaped recording medium, and for initiating a recording operation based on the program setting information read from the disc-shaped recording medium; wherein, when weekly-program setting indicating recording for a specified period of time beginning at a fixed time on a fixed day every week is designated as the program setting information, and when single-program setting is designated for a program broadcasted at an overlapping time slot on the same day of a week on a specific date, the recording controller performs a recording operation preferentially for the single-program setting without canceling the weekly-program setting.

According to this feature, without canceling weekly-program setting, program setting for a program (single-program setting) can be designated, on a specific date, at the overlapping time slot on the same day of a week as the weekly-program setting. In this case, during recording of the single program, the recording controller regards the weekly-program setting as ineffective, and when the recording of the single program is completed, regards the weekly-program setting as effective again. Thus, thereafter, the weekly-program setting is effective again, and recording of the same program is performed every week.

An optical disc apparatus according to another aspect of the invention includes: a recording controller for recording to a predetermined area of a disc-shaped recording medium weekly-program setting information indicating recording for a specified period of time beginning at a fixed time on a fixed day of every week, and for initiating a recording operation based on the weekly-program setting information read from the disc-shaped recording medium; and a display unit for displaying a setup screen to designate the weekly-program setting information; wherein, for the setup screen displayed on the display unit, a weekly-program setting entry field for one program includes an upper row as a weekly-program setting row and a lower row as a single-program setting row that is for program setting for a full-length program broadcasted at an overlapping time slot on the same day of a week on a specific date; wherein, when only weekly-program setting is entered to the weekly-program setting row on the setup screen, the recording controller performs weekly-program setting as usual; and wherein, when weekly-program setting is entered to the weekly-program setting row on the setup screen, and single-program setting is entered to the single-program setting row the recording controller performs the recording operation preferentially for the single-program setting without canceling the weekly-program setting.

According to this feature, since the weekly-program setting row and the single-program setting row are provided respectively for the upper portion and the lower portion on the program setting setup screen, the user can employ the overlapping weekly-program setting screen to designate single-program setting. In this case, when the weekly-program setting is entered to the weekly-program setting row on the setup screen and the single-program setting is entered to the single-program setting row, the recording controller performs the recording operation preferentially for the single-program setting, without canceling the weekly-program setting. Therefore, while the weekly-program setting and the single-program setting are appropriately adjusted, the single-program setting can be performed without canceling the weekly-program setting.

In this case, an overwriting selection column for selecting overwriting during recording is provided for the weekly-program setting entry field for each program on the setup screen. When overwriting is selected for single-program setting, the recording controller may vary a bit rate and perform a recording operation by overwriting programs while taking a recording period into account. With this arrangement, for example, when a one-hour program is designated for weekly-program setting, and a two-hour special program is designated for single-program setting, the recording controller can vary a bit record and record the special program having the different recording hours in the same recording area on the optical disc.

Furthermore, in this case, the optical disc apparatus may further include: a display unit for, when the single-program setting is designated, displaying a list of recorded programs that have been already recorded on the disc-shaped recording medium; wherein, when weekly-program setting is entered to the weekly-program setting row on the setup screen and single-program setting is entered to the single-program setting row, the recording controller performs a recording operation preferentially for the single-program setting, without canceling the weekly-program setting; wherein, when overwriting is selected when the single-program setting is designated, and when one or a plurality of programs to be overwritten are selected by a user from the list of the recorded programs, the recording controller determines a recording bit rate while taking into account an area obtained by adding a recorded area of all the selected programs to an recording area for the weekly-program setting, and employs the determined bit rate to perform the recording area by overwriting programs.

According to this arrangement, when a user designates, for example, a two-hour program for full-length unattended recording without deterioration of an image quality, the user selects, from a recorded program list screen, one or a plurality of programs to be overwritten. For example, when a one-hour program is designated for weekly-program setting, a user selects, on the recorded program list screen, one another program (or two thirty-minutes programs) to be overwritten. Then, since an overwriting and recording area for two hours is obtained, the recording controller can record the two-hour program, by overwriting the old programs, at the same bit rate as the bit rate for weekly-program setting.

### BRIEF DESCRIPTION OF THE DRAWINGS

FIG. 1 is a circuit block diagram showing a DVD recorder that is an optical disc apparatus according to one embodiment of the present invention;

FIG. 2 is a diagram for explaining an example setup screen to designate weekly-program setting; and

FIG. 3 is a diagram for explaining an example list for recorded programs.

### DETAILED DESCRIPTION OF THE PREFFERED EMBODIMENTS

A preferred embodiment of the present invention will now be described while referring to the drawings.

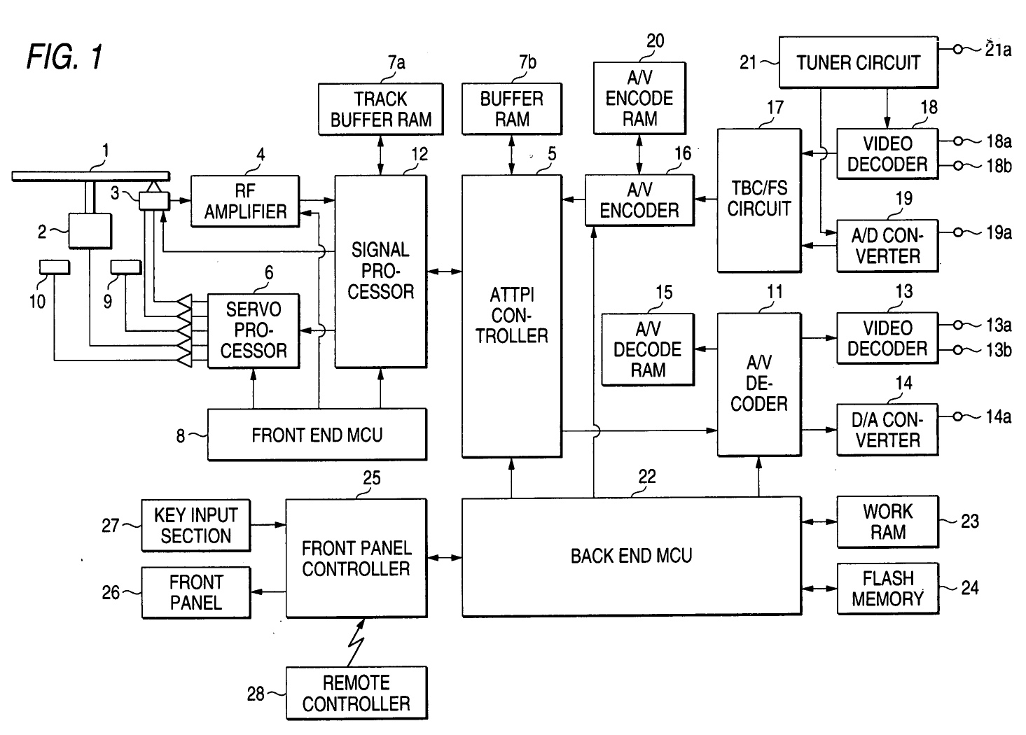

FIG. 1 is a circuit block diagram showing a DVD recorder constituting an optical disc apparatus according to the embodiment of the present invention.

In FIG. 1, an optical pickup 3 detects information on an optical disc 1 rotated by a disc motor 2, and outputs the information, via an RF amplifier 4, to an ATAPI controller 5 and a signal processor 12. A track buffer RAM (e.g., an SDRAM) 7a, which is connected to the signal processor 12, is used to temporarily store data that are amplified by the RF amplifier 4 and decoded in accordance with a DVD standard (in this embodiment, data are compressed using the MPEG (Moving Picture Experts Group) standard). The RF amplifier 4 and the signal processor 12 are controlled by a front end MCU 8.

In accordance with a command, and control data exchanged with the front end MCU 8 via the signal processor 12, a servo processor 6 provides servo control, such as for focusing servo and tracking servo, for the optical pickup 3 and also controls a thread motor 9, which moves the entire optical pickup 3 in the radial direction of the optical disc 1, and a tray motor 10, which drives a tray (not shown) on which an optical disc 1 is mounted.

The signal processor 12 is connected to an A/V (Audio/Video) decoder 11 via the ATAPI controller 5, to which a buffer RAM 7b is connected, and the output terminal of the A/V decoder 11 is connected to a video encoder 13, having video output terminals 13a and 13b, and a D/A converter 14, having an audio output terminal 14a. The A/V decoder 11 expands MPEG compressed data that are read from the track buffer RAM 7a. Furthermore, connected to the A/V decoder 11 is an A/V decode RAM (e.g., an SDRAM) 15, for storing decompressed digital data for several screens. The video output terminals 13a and 13b and the audio output terminal 14a are connected to the corresponding input terminals of a television receiver (not shown).

The output terminal of the video decoder 18, for which video input terminals 18a and 18b are provided, and the output terminal of an A/V converter 16, which has an audio input terminal 19a, are connected to an A/V encoder 16 via a TBC/FS (Time Base Corrector/Frame Synchronizer) circuit 17, and the output terminal of the A/V encoder 16 is connected to the signal processor 12 via the ATAPI controller 5. The signals output by a tuner circuit 21, which has an antenna terminal 21a, are transmitted to the video decoder 18 and the A/D converter 19. The A/V encoder 16 uses MPEG to compress data stored in the A/V encode RAM 20, and outputs the compressed data to the ATAPI controller 5.

The ATAPI controller 5, the A/V decoder 11 and the A/V encoder 16 are connected to a back end MCU 22, to which a work RAM 23 and a flash memory 24 are also connected.

Further, a front panel controller 25, for controlling the display on a front panel 26 such as an LCD, is connected to the back end MCU 22, and a signal output by a key input section 27 is transmitted to the front panel controller 25. A receiver (not shown), for receiving a signal from a remote controller 28, is provided for the front panel controller 25.

A brief explanation will now be given for the recording operation and the reproduction operation of the thus arranged DVD recorder. It should be noted that an explanation will be given for the recording operation performed when a signal is received from the tuner circuit 21.

The recording operation will be described first.

A program broadcast signal is received through the antenna terminal 21a, and the tuner circuit 21 separates the program broadcast signal into an analog video signal and an analog audio signal. The video decoder 18 converts the analog video signal into a digital signal, and transmits the digital signal to the TBC/FS circuit 17. Similarly, the A/D converter 19 converts the analog audio signal into a digital signal, and transmits the digital signal to the TBC/FS circuit 17. The TBC/FS circuit 17 performs the time axis correction process and the frame synchronization process for the received signals, and transmits the resultant signals to the A/V encoder 16. The A/V encoder 16 compresses video data by MPEG, compresses audio data and adds NV_PCK (RDI_PCK in the VR mode) to generate data stream. The stream data are temporarily stored in the A/V encode RAM 20, are read again and are sequentially transmitted to the ATAPI controller 5. The ATAPI controller 5 sequentially stores the received video data in the buffer RAM 7b. At this time, the back end MCU 22 adds necessary information for NV_PCK (RDI_PCK in the VR mode). Thereafter, a writing instruction from the back end MCU 22 is waited for.

When the front end MCU 8 receives a writing instruction from the back end MCU 22, the front end MCU 8 reads the data stored in the buffer RAM 7b, and transmits the data through the ATAPI controller 5 to the signal processor 12, and the data are temporarily stored in the buffer RAM 7a. Then, the servo processor 6 and the optical pickup 3 are controlled to record the data on the optical disc 1.

The reproduction operation will now be described.

When the front end MCU 8 receives a reading instruction from the back end MCU 22, the front end MCU 8 controls the optical pickup 3 through the servo processor 6. Thus, the data recorded on the optical disc 1 are detected by the optical pickup 3, and the waveform of the data is shaped and the data are amplified by the RF amplifier 4. Thereafter, the resultant data are sequentially transmitted through the signal processor 12 and stored in the buffer RAM 7b of the ATAPI controller 5.

The data stored in the buffer RAM 7b are transmitted to the A/V decoder 11. The MPEG compressed data are expanded and decoded to obtain video data, and the obtained video data are stored in the A/V decode RAM 15. Thereafter, the video data are read again, are sequentially transmitted to the video encoder 13, and are converted into analog video signals. These analog video signals are output from the video output terminals 13a and 13b to the monitor screen of a television receiver (not shown).

As well as the video data, the audio data are transmitted from the buffer RAM 7b to the A/V decoder 11, and are stored in the A/V decode RAM 15. Then, the audio data are read again, are sequentially transmitted to the D/A converter 14, and are converted into analog audio signals. These audio analog signals are output from the audio output terminal 14a and the built-in microphone of the television receiver (not shown).

In this embodiment, the feature of the thus arranged DVD recorder is the program setting processing. Specifically, program setting information is recorded in a predetermined area (user data area) of the optical disc 1, and when the optical disc 1 is loaded into the optical disc apparatus, the program setting information is read from the user data area of the optical disc 1, and is stored in, for example, the work RAM 23, and the back end MCU 22 controls the recording operation based on the program setting information. This control operation is maintained until the current optical disc 1 is discharged from the optical disc apparatus. When the optical disc 1 is unloaded, the program setting information stored in the work RAM 23 is erased.

Weekly-program setting information, indicating recording for a specified period beginning at a fixed time on a fixed day every week, can be recorded on the optical disc 1, and a setup screen for designating weekly-program setting is displayed on the screen of, for example, a television receiver (not shown).

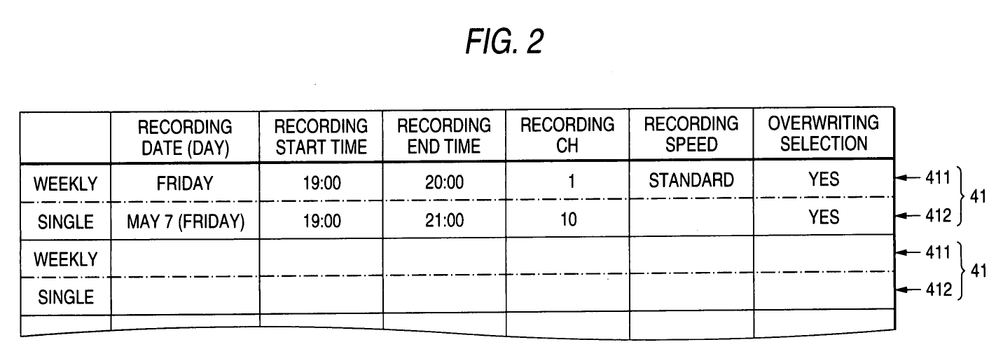

On the setup screen, as is shown in FIG. 2, a weekly-program setting entry field 41 for one program is constituted by an upper row and a lower row. The upper row is a weekly-program setting row 411, and the lower row is a single-program setting row 412 that is for program setting for a full-length program broadcasted at the overlapping time slot on the same day on a specific date. The rows 411 and 412 include columns of a recording date (day), a recording start time, a recording end time, a recording channel, a recording speed and overwriting selection.

On the setup screen, the user can employ the overlapping weekly-program setting screen to designate single-program setting for a full-length program, such as a special program.

When the weekly-program setting is entered to the weekly-program setting row 411 on the setup screen and single-program setting is entered to the single-program setting row 412, the back end MCU 22 performs the recording operation preferentially for the single-program setting, without canceling the weekly-program setting.

For example, as is shown in FIG. 2, assume that “Friday” is entered to the recording date (day) of the weekly-program setting row 411, “19:00” is entered to the recording start time column, “20:00” is entered to the recording end time column, “1 CH” is entered to the recording channel column, “standard” is entered to the recording speed column, and “overwrite selected” is entered to the overwrite selection column. Further, assume that “Friday, May 7” is entered to the recording date (day) of the single-program setting row 412, “19:00” is entered to the recording start time column, “21:00” is entered to the recording end time column, “10 CH” is entered to the recording channel column and “overwrite selected” is entered to the overwrite selection column. In this case, while, at 19:00 on every Friday, the back end MCU 22 records a one-hour program on channel 1 in the standard mode by overwriting, at 19:00 on Friday, May 7, the back end MCU 22 performs the recording operation under the conditions designated in the single-program setting row 412. At this time, the back end MCU 22 regards the weekly-program setting as ineffective, instead of canceling it, and performs the recording operation preferentially for the single-program setting. After the single-program setting is completed, the back end MCU 22 continues the recording again in accordance with the weekly-program setting. That is, on Friday next week, i.e., May 14, the back end MCU 22 records, by overwriting, the program on channel 1 for one hour from 19:00 to 20:00 in accordance with the conditions designated in the weekly-program setting row 411. As is described above, the back end MCU 22 appropriately adjusts the weekly-program setting and the single-program setting internally, and performs the single-program setting, without canceling the weekly-program setting.

In this case, an overwriting selection column for selecting overwriting is provided for the weekly-program setting entry field for each program on the setup screen. In this embodiment, “overwriting selected” is entered to the overwriting selection. In this case, when a full-length two-hour program must be recorded in an area where one-hour data are recorded, the back end MCU 22 varies the bit rate of data (specifically, changes the bit rate to ½), so as to perform the overwriting and recording operation, while taking into account the recording period, i.e., the recording area. Therefore, a two-hour special program having a different recording period can be recorded on the same recording area on the optical disc 1.

In this case, the bit rate is reduced to record data for a two-hour special program to a recording area for one hour. However, the image quality would be deteriorated when the special program is reproduced. Thus, in this embodiment, when single-program setting is designated, a list of recorded programs that have been recorded on the loaded optical disc 1 is displayed on the screen of the television receiver (not shown), so that a user can select, on the list, one or more programs to be overwritten.

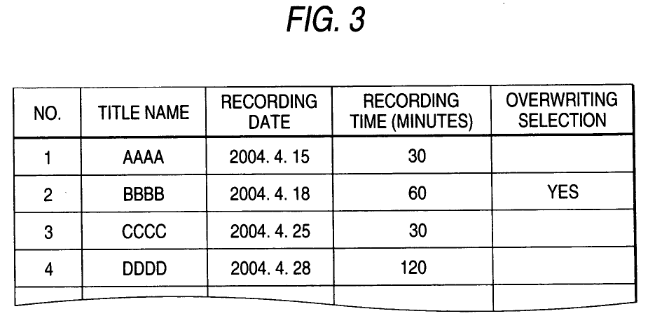

FIG. 3 is a diagram showing an example list of recorded programs. The list of recorded programs includes a recording number, a title name, a recording date, a recording time (minute) and overwriting selection.

When, at the single-program setting, a user displays the list of recorded programs and selects the overwriting selection row of a desired recorded program, the recording area of the selected recorded program can be obtained as an additional recording area used for the single-program setting. For example, when the user selects recorded program of No. 2 (title name: BBBB) (“Yes” in FIG. 3), in addition to the hone-hour recording area for weekly-program setting, the one-hour recording area used for the recorded program of No. 2 is obtained as the recording area for the single-program setting.

The back end MCU 22 determines the recording bit rate for single-program setting, while taking into account, an area obtained by adding the recording area used for the selected recorded program to the recording area for the weekly-program setting. In this example, the back end MCU 22 determines the same bit rate as the bit rate for the weekly-program setting, and in accordance with the single-program setting, records a two-hour special program, at this bit rate, to the recording area for the weekly-program setting and by overwriting the recording area for the recorded program of No. 2. As a result, the two-hour special program can be recorded without deteriorating the image quality.

1. An optical disc apparatus comprising:
recording control means for recording to a predetermined area of a disc-shaped recording medium weekly-program setting information for performing recording for a specified period of time beginning at a fixed time on a fixed day of every week, and for initiating a recording operation based on the weekly-program setting information read from the disc-shaped recording medium;
first display means for displaying a setup screen to designate the weekly-program setting information; and
second display means;
wherein, for the setup screen displayed on the first display means, a weekly-program setting entry field for one program includes an upper row as a weekly-program setting row and a lower row as a single-program setting row that is for program setting for a single program broadcasted at an overlapping time slot on the same day of a week on a specific date, and an overwriting selection column for selecting overwriting during recording is provided for the weekly-program setting row and the single-program setting row;
wherein, when single-program setting is designated, the second display means displays a list of recorded programs that have been already recorded on the disc-shaped recording medium;
wherein, when only weekly-program setting is entered to the weekly-program setting row on the setup screen, the recording control means performs the weekly-program setting;
wherein, when the weekly-program setting is entered to the weekly-program setting row on the setup screen and the single-program setting is entered to the single-program setting row, the recording control means performs the recording operation preferentially for the single-program setting without canceling the weekly-program setting; and
wherein, when overwriting is selected when the single-program setting is designated, and when one or a plurality of programs to be overwritten are selected by a user from the list of the recorded programs, the recording control means determines a recording bit rate while taking into account an area obtained by adding a recorded area of all the selected programs to an recording area for the weekly-program setting, and employs the determined bit rate to perform the recording operation by overwriting the selected programs.

2. An optical disc apparatus comprising:
a recording controller for recording program setting information to a predetermined area of a disc-shaped recording medium and for initiating a recording operation based on the program setting information read from the disc-shaped recording medium;
wherein, when weekly-program setting, indicating recording for a specified period of time beginning at a fixed time on a fixed day every week, is designated as the program setting information, and when single-program setting is designated for a single program broadcasted at an overlapping time slot on the same day of a week on a specific date, the recording controller performs a recording operation preferentially for the single-program setting without canceling the weekly-program setting.

3. An optical disc apparatus comprising:
a recording controller for recording to a predetermined area of a disc-shaped recording medium weekly-program setting information indicating recording for a specified period of time beginning at a fixed time on a fixed day of every week, and for initiating a recording operation based on the weekly-program setting information read from the disc-shaped recording medium; and
a display unit for displaying a setup screen to designate the weekly-program setting information;
wherein, for the setup screen displayed on the display unit, a weekly-program setting entry field for one program includes an upper row as a weekly-program setting row and a lower row as a single-program setting row that is for program setting for a single program broadcasted at an overlapping time slot on the same day of a week on a specific date;
wherein, when only weekly-program setting is entered to the weekly-program setting row on the setup screen, the recording controller performs the weekly-program setting; and
wherein, when the weekly-program setting is entered to the weekly-program setting row on the setup screen, and single-program setting is entered to the single-program setting row, the recording controller performs the recording operation preferentially for the single-program setting without canceling the weekly-program setting.

4. The optical disc apparatus according to claim 3, wherein an overwriting selection column for selecting overwriting during recording is provided for the weekly-program setting entry for each program on the setup screen; and
wherein, when overwriting is selected for the single-program setting, the recording controller varies a bit rate and performs a recording operation by overwriting programs while taking a recording period into account.
